(19) United States
(12) Patent Application Publication
(10) Pub. No.: US 2004/0054563 A1
(43) Pub. Date: Mar. 18, 2004

(54) Method for managing enterprise risk

(76) Inventor: William J. Douglas, Strafford, PA (US)

Correspondence Address: David G. Wille, Esq., Baker Botts L.L.P., Suite 600, 2001 Ross Avenue, Dallas, TX, 75201-2980, US

(21) Appl. No.: 10/246,023

(22) Filed: Sep. 17, 2002

(51) Int. Cl. G06F 17/60

(52) U.S. Cl. 705/7

(57) ABSTRACT

Risk management information is collected from each of a plurality of separate entities according to a common standard, and then at least one of the entities is provided with a report comparing all the entities as a function of the risk management information. In a different approach, risk management information is collected from each of a plurality of separate sections of an entity according to a common standard, where the information from each section includes information about risk incidents experienced and about costs incurred to manage risks. A report is then prepared to compare the sections of that entity as to risk management, based on the information collected.

### TECHNICAL FIELD OF THE INVENTION

This invention relates in general to risk management and, more particularly, to techniques for improving risk management performance of an entity.

### BACKGROUND OF THE INVENTION

Businesses and other entities face various risks which can cause unexpected costs that affect financial performance. Risks are unforeseen incidents that incur unexpected costs, which in turn affect financial performance. For example, risks include losses that are not covered by insurance or that exceed available insurance, such as losses due to fire, accidents, explosions, government fines or court judgments. As another example, a computer system problem resulting in a processing failure may cause a multi-million dollar financial loss, due to lost transactions. In some instances, the loss from a risk incident can affect the financial performance of an entity so severely that the ultimate result is the demise of the entity, for example through a forced bankruptcy.

Risk cannot be eliminated, but it can be managed. Some entities collect and analyze data on risk incidents, and compare it with publicly available information. Other entities collect information which indirectly relates to risk, such as numbers of accidents, numbers of lost work hours, and data about business transactions such as sales or loans in which errors or fraud occur. On the other hand, some entities make no intentional effort to track risk at all. But even where entities attempt to address risks, risks are typically not managed in an effective manner.

### SUMMARY OF THE INVENTION

From the foregoing, it may be appreciated that a need has arisen for techniques that provide better capability for managing risk. The present invention is intended to address this need, and a first form of the invention involves: collecting risk management information from each of a plurality of separate entities according to a common standard; preparing a report which provides a comparison of the entities as a function of the risk management information; and providing the report to one of the entities.

A second form of the present invention involves: collecting risk management information from each of a plurality of separate sections of an entity according to a common standard, the risk management information from each section including information regarding risks experienced and regarding costs incurred to manage risks; preparing a report which provides a comparison of the sections as a function of the risk management information; and providing the report to one of the entities and/or a section thereof.

### BRIEF DESCRIPTION OF THE DRAWINGS

A better understanding of the present invention will be realized from the detailed description which follows, taken in conjunction with accompanying drawings, in which:

FIG. 1 is a flowchart showing a method which facilitates effective risk management by each of several entities, and which embodies aspects of the present invention;

FIGS. 2-5 are each a bar graph generated during the method of FIG. 1 for a respective one of four risk categories, and each show respective scores in that category for each of the entities participating in the method;

FIG. 6 is a bar graph generated during the method of FIG. 1, showing a respective composite score across all risk categories for each of the participating entities;

FIG. 7 is a bar graph generated during the method of FIG. 1, showing for each of the participating entities a respective composite score which is different from the composite score shown in FIG. 6;

FIG. 8 is a bar graph generated during the method of FIG. 1, showing the number of past risk incidents experienced by an entity in each of several cost ranges;

FIG. 9 is a graph generated during the method of FIG. 1, showing a cumulative loss distribution curve representing the probability that total annual losses of an entity will exceed any given value, based on historical performance;

FIGS. 10-15 are respective graphs generated during the method of FIG. 1 which each correspond to a respective one of the six risk types, and which each show for each of several business units of a given entity a normalized cost of risk management and a normalized value representing past risk-related incidents;

FIG. 16 is a graph generated during the method of FIG. 1, which is similar to the graphs of FIGS. 10-15 except that it shows for the business units of the given entity across all six risk types a normalized cost of risk management and a normalized value representing past risk-related incidents;

FIG. 17 is a graph generated during the method of FIG. 1, which is similar to the graphs of FIGS. 10-16 except that it shows for each of the participating entities across all six risk types a normalized cost of risk management and a normalized value representing past risk-related incidents;

FIG. 18 is a graph generated during the method of FIG. 1, showing four curves which each correspond to one of four hypothetical projects selected by a participating entity, where the horizontal axis represents the degree of investment in each project, and the vertical axis represents the expected benefit from each project; and

FIGS. 19 and 20 are graphs generated during the method of FIG. 1, showing how the risk management performance of a given business unit of a participating entity changes over time.

### DETAILED DESCRIPTION OF THE INVENTION

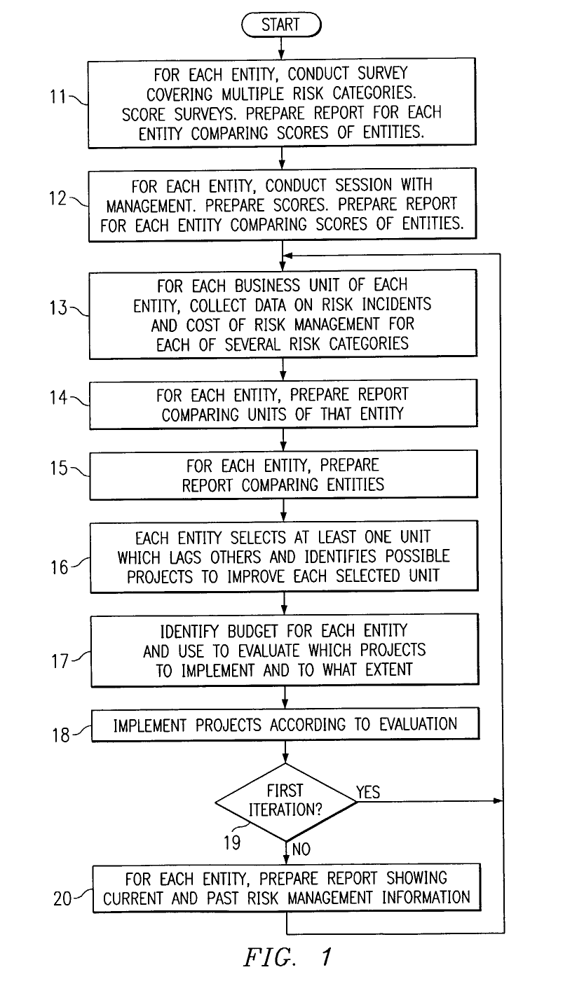

FIG. 1 is a flowchart showing a method which facilitates effective risk management, and which embodies aspects of the present invention. In this regard, and as discussed above, risks can cause unexpected costs that affect financial performance of a business enterprise or other entity. In some instances, risks can lead to the demise of an entity, for example due to a large loss that exceeds assets and forces the entity into bankruptcy. Risk cannot be eliminated, but it can be managed. However, most entities either make no attempt to manage risk, or else do not manage risk effectively. The method shown in FIG. 1 is designed to simultaneously help several entities manage risk in an effective manner.

Before describing the method of FIG. 1 in detail, it is appropriate to explain that the method shown in FIG. 1 involves the simultaneous participation of several independent entities. For convenience and clarity, the method will be explained in the context of a hypothetical situation involving ten separate and independent entities which are each a business corporation. These ten corporations are respectively referred to here as Q Corporation, R Corporation, S Corporation, T Corporation, U Corporation, V Corporation, W Corporation, X Corporation, Y Corporation, and Z Corporation. The hypothetical scenario will be discussed primarily from the perspective of X Corporation, which for convenience will referred to as Xcorp. It is assumed that each of these ten corporations has two or more business units, such as subdivisions. Focusing specifically on Xcorp, it is assumed that Xcorp has seven business units or subdivisions, which for convenience will be referred to as business units A, B, C, D, E, F, and G. The method also involves a third-party service provider, which cooperates with all ten business entities by serving as a central facilitator and coordinator for the implementation of the method.

It will be recognized that, as a practical matter, one or more of the entities which begin the method may drop out at some point during the method, such there is a negligible decrease in the number of entities participating in the method. However, for purposes of simplicity and clarity, the following discussion assumes that all ten hypothetical entities continue to participate in the process.

Turning now in more detail to FIG. 1, the method begins in block 11, where several persons at each of the ten participating entities complete a survey that addresses several risk categories. The surveys are administered and scored by the third-party facilitator. For convenience, the survey may be presented in an on-line form, for example as an Internet page on the World Wide Web (WWW) which can be accessed through use of respective passwords supplied to each of the persons participating in the survey. Precisely the same survey is used for each such person. The purpose of the survey is to identify the current status of each participating entity with regard to its existing risk management program and activities, or in other words to answer the question: “Where are you now?”.

The method of FIG. 1 recognizes four primary categories of operational risk, which are (1) people, (2) processes, (3) systems, and (4) external events. However, it would alternatively be possible to use a different categorization, and/or a larger or smaller number of categories. TABLE 1 shows part of a survey used for the hypothetical scenario.

TABLE 1

| RISK CATEGORY | STATEMENTS |
|---|---|
| People | Our organization conducts background |
| | checks on all employees. |
| | We have a published policy regarding |
| | harassment in the workplace that is |
| | available to all employees. |
| | We monitor and record incidents |
| | relating to harassment and workplace |
| | satisfaction. |
| | We conduct drug screening of new |
| | hires. |
| | . |
| | . |
| | . |
| Processes | Our organization has published risk |
| | management policy and procedures. |
| | The policy statement is signed by a |
| | corporate executive. |
| | We regularly review processes to |
| | identify weakness points. |
| | Each of our critical mission processes |
| | has an identified owner. |
| | . |
| | . |
| | . |
| Systems | Our organization has a standard |
| | approach for dealing with viruses. |
| | We have a procedure for managing |
| | passwords and information access. |
| | We monitor and record unauthorized |
| | access to our information systems. |
| | We monitor and record incidents of |
| | net abuse. |
| | . |
| | . |
| | . |
| External Events | Our organization reviews the |
| | effectiveness of its facility |
| | insurance programs annually. |
| | Our facilities are evaluated regularly |
| | for access and workplace security. |
| | We have published procedures and train |
| | our staff in dealing with emergency |
| | situations. |
| | We monitor and record information |
| | relating to uninsured incidents. |
| | . |
| | . |
| | . |

It can be seen from TABLE 1 that, for each risk category, a number of statements are presented to the person taking the survey. A person participating in the survey will see only the statements, without an indication of the category associated with each statement. Further, the statements will typically be presented to the person in an order different from the order shown in TABLE 1, so that statements from the various categories are intermixed with each other. The person taking the survey is asked to evaluate each statement in relation to his or her business entity, and to then assign the statement a numeric value in the form of one of seven integers on a scale from 1 to 7, where 1 represents strong disagreement with the statement, and 7 represents strong agreement with the statement.

Next, and still referring to block 11 in FIG. 1, the input received from the surveys is used to calculate scores. In this regard, for each of the ten participating entities, the surveys completed by the people from that entity are used to calculate a separate score for each of the four different risk categories. To facilitate this scoring, each statement on the survey has a preassigned weighting factor. More specifically, for a given risk category and a given entity, the score would be calculated as follows:

$${Score}_{category} = {\sum }_{i = 1}^{N} {W}_{i} ( {\sum }_{j = 1}^{M} {S}_{ij} )$$

where there are N statement in the relevant category of the survey, where M persons from the selected entity participated in the survey, where Sᵢⱼ is the respective numerical value assigned to a given statement by a respective participant, and where Wᵢ is the respective weighting factor associated with each statement in the relevant category. Each of the resulting category scores for each entity is then normalized to a scale where 100 represents a maximum score, or in other words the score which would be calculated if every statement had been given a numeric value of 7 by every participant.

Next, for each entity, the four scores from the four categories are combined. In the disclosed embodiment, the four category scores are added together, and then normalized to a scale having 100 as the maximum score. Alternatively, however, each category could be assigned a respective weighting factor, and the four weighted category scores could added and normalized.

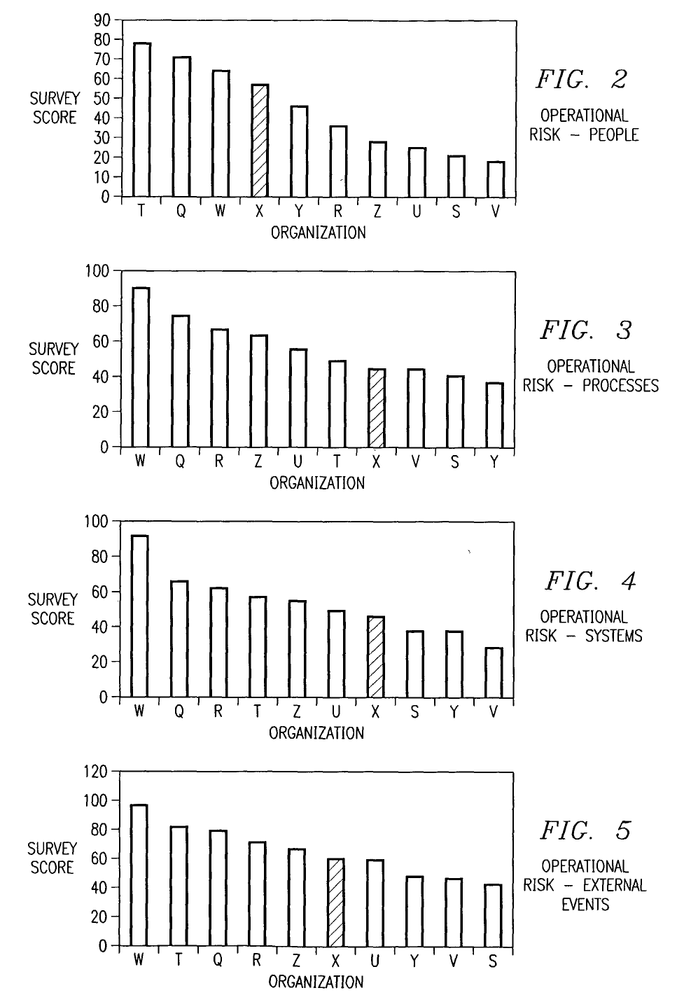

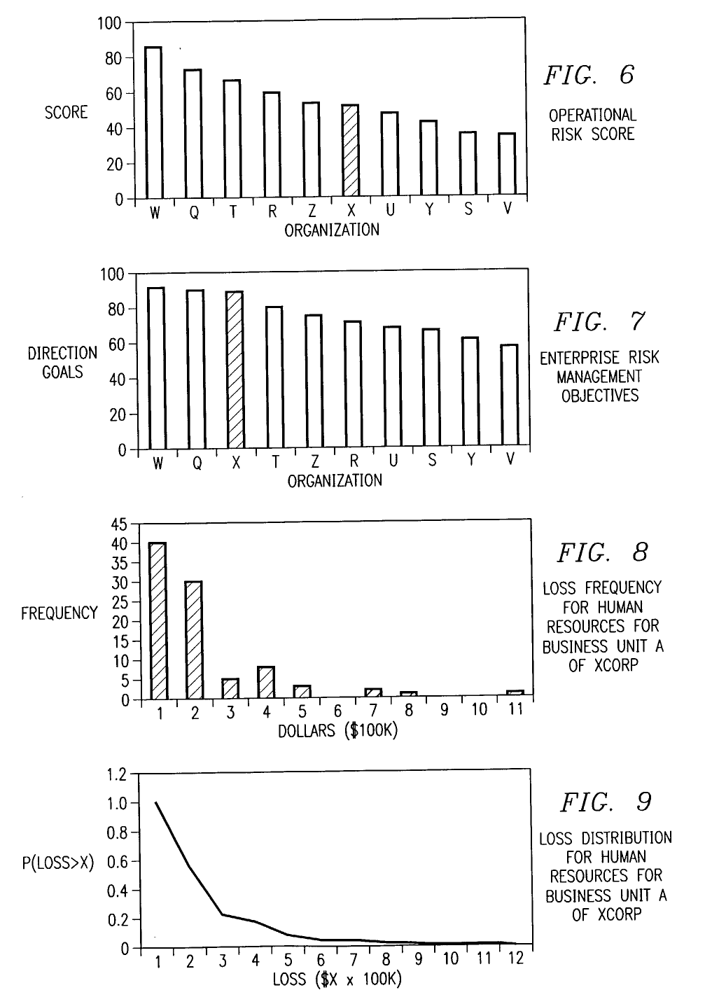

Thereafter, and still referring to block 11 in FIG. 1, a report is prepared and provided to each participating entity, in order to provide comparative information regarding the scores obtained for each entity. Each such report provides real world value and immediate benefit to the entity which receives it. In this regard, and in the context of the hypothetical scenario under discussion, FIGS. 2-5 are each an example of a bar graph showing the respective scores for all ten entities in a respective one of the four risk categories (people, processes, systems and external events). FIG. 6 is a bar graph showing respective composite scores for all ten entities across all four categories.

In general, FIGS. 2-6 represent the version of the report which is provided to Xcorp, and thus the scores of Xcorp are highlighted in each of these graphs, and are labeled with the corporation's name (“X”) . For purposes of clarity in explaining the present invention, the graphs in FIGS. 2-6 also include labels (Q-W and Y-Z) which represent the corporate names of the other nine entities. However, in the version of the report which is actually given to Xcorp, only the scores of Xcorp would have labels, and the scores of the other nine entities would not have labels. Thus, Xcorp could easily identify its own scores, and see how its scores compare to those of the other nine entities, but Xcorp would not know which other entities were participating, and would not know which scores corresponded to which of the other entities. Each of the other participating entities would be given a report generally similar to the report given to Xcorp, except that in each such report the scores of the recipient entity would be highlighted and labeled, but the scores of the other entities would not be highlighted or labeled.

The method next moves to block 12 in FIG. 1, where the third-party facilitator separately meets with a senior management team from each of the ten entities participating in the process, in order to conduct a respective consensus group session for each such entity. The purpose of each such session is to assess the extent to which each such management team is interested in working to improve the current risk management status of its entity. Stated differently, the purpose of each such session is to answer the question: “Where do you want to be?” Each such session involves evaluation of a series of statements, examples of which are set forth in TABLE 2. The statements in TABLE 2 are personalized for use with Xcorp, but it will be recognized that a respective different entity name would be substituted for “Xcorp” when the statements of TABLE 2 are utilized for each of the other nine entities.

TABLE 2
STATEMENTS

Xcorp is committed to a world class risk management
program.
Xcorp executives will support an appropriate investment
in achieving its risk management objectives.
Xcorp is willing to collect and report quantitative
information relating to its risk and its costs in
managing these risks.
Xcorp wants to maintain benchmarking standards to
measure its performance against its peers.
Xcorp prefers to take a moderate position in risk
management with minimum disruption to current
processes.

.
.
.

The evaluation of the statements set forth in TABLE 2 is carried out in a manner different from the manner in which the statements in TABLE 1 were evaluated. In the case of the statements in TABLE 1, several different persons each participated in the survey on a separate and independent basis, without interacting with each other or the third-party facilitator. In contrast, in each consensus group session utilizing the statements in TABLE 2, the third-party facilitator meets with a group of several persons from a given entity, who collectively evaluate each statement, and who are required to reach a consensus regarding a numerical score to assign to each statement. Each numerical score is one of seven integers on a scale from 1 to 7, where 1 represents strong disagreement with the statement, and 7 represents strong agreement with the statement. For a given statement, some persons in the group may believe that the statement should be assigned a numerical value of 3, and others may believe that it should be assigned a value of 5, and through compromise they may ultimately reach a consensus to assign the statement a value of 4. One of the functions of the third-party facilitator is to ensure that the group reaches consensus regarding a single respective numerical value to assign to each statement in TABLE 2.

Upon completion of the consensus group session for each of the ten entities, the various scores assigned to the various statements for each entity are combined into a composite score for that entity. In this regard, each statement in TABLE 2 may have an associated weighting factor. The score assigned to each statement is multiplied by its respective weighting factor, and then the weighted values are added up to obtain a composite score for that entity. The composite score is then normalized to a scale having a maximum value of 100, where 100 corresponds to the maximum possible score that would result where a consensus group session assigned a value of 7 to every statement considered.

Next, and still referring to block 12 in FIG. 1, a report is prepared for each entity, in order to provide a comparison of the respective composite scores for the ten participating entities. In this regard, FIG. 7 is an example of a bar graph showing the respective composite scores for all ten of the entities participating in the process. FIG. 7 represents the version of the graph which would appear in the report provided to Xcorp, and thus the composite score for Xcorp has been highlighted and labeled. As discussed above, labels in the form of letters representing the names of the other nine corporate entities are shown in FIG. 7 for clarity, but would actually be omitted from the report provided to Xcorp. Each of the other nine participating entities would receive essentially the same report, except that in each such report the scores of the recipient entity would be highlighted and labeled, but the scores of other entities would not be highlighted or labeled.

The information provided in the graph of FIG. 7 can help each of the ten entities assess how aggressively it is pursuing risk management, in comparison to the other nine participating entities. The reports containing these graphs thus provide real world value and immediate benefit.

As mentioned above, it is possible that an entity might choose to drop out of the process at this point, if it found that the information provided in graphs of the type shown in FIGS. 2-7 reflected that the entity was already handling risk management in an aggressive and efficient manner. However, as will become evident from the discussion which follows, the method of FIG. 1 is periodically repeated, and an entity which ranked high in the initial reports might find that it had dropped significantly in the rankings by the second or third set of reports, because entities which were initially ranked very low made significant adjustments to their approaches to risk management. Consequently, all of the entities would be strongly motivated to continue to participate. Therefore, and as mentioned above, it is assumed for purposes of the present hypothetical scenario that all of the ten entities continue to participate in the method of FIG. 1.

Activity in the method of FIG. 1 next moves to block 13, where risk information is collected from each entity on a significantly more detailed level for a specified time period, such as a calendar year, a fiscal year, or a fiscal quarter. Generally speaking, there are two different ways to collect this detail. First, it may be possible to extract information from existing records and databases of each entity, such as financial software utilized by each entity to maintain its accounting system. The second approach is to provide persons associated with the entity some forms that specify needed data, after which those persons would locate the specified data and enter it into the forms. Since creation and manual completion of the forms may represent a greater burden than extracting data from existing resources, the approach of extracting data from existing resources will be typically be used wherever it is reasonably feasible. For most entities, however, a combination of both approaches will probably be used.

The detailed data which is to be collected falls into two general categories. The first general category is risk information relating to risk incidents. The second general category is cost information relating to costs incurred to manage risk.

Beginning with the general category of risk information, risk is defined to be unforeseen incidents that incur unexpected costs which in turn affect financial performance of an entity. Examples of these unexpected costs are losses due to fire, accidents, explosions, government fines, or court awards. Some entities collect and analyze data regarding risk incidents, for comparison to publicly available risk information. Other entities collect information relating indirectly to risk, such as numbers of accidents, numbers of lost work hours, or information about transactions such as sales or loans where errors or fraud occur. In contrast, some entities make no conscious effort to collect risk information.

In order to collect risk information which will be meaningful for the purpose of comparing several entities to each other, each entity participating in the method of FIG. 1 needs to collect risk information according to a common standard. In this regard, TABLE 3 shows in the left column the four general risk categories which have already been discussed above. The middle column shows six risk types, which are each classified into one of the four risk categories. The right column lists, for each risk type, some specific incidents falling within that particular risk type. The categories, risk types and incidents listed in TABLE 3 are exemplary, and it will be recognized that there could be a larger or smaller number of categories, that the categories could be defined differently, that there could be a larger or smaller number of risk types, that the risk types could be defined differently, that there could be a larger or smaller number of incidents, and that some or all of the specific incidents could be different.

TABLE 3

| RISK | | |
|---|---|---|
| CATEGORY | RISK TYPE | INCIDENTS |
| People | Human | Discrimination |
| | Resources | Harassment |
| | | Information Disclosure |
| | | Fraud |
| Processes | Loan | Fiduciary Failure |
| | Processing | Inadequate Review |
| | | Input Errors |
| | Security | Mispricing |
| | Trading | Reconciliation Failure |
| | | Inadequate Review |
| Systems | Hardware | Outage |
| | Systems | Malfunction |
| | Software | Virus |
| | Systems | Malfunction |
| External | Facility | Power/water outage |
| Events | Security | Fire |
| | | Vandalism |

As mentioned above, each of the ten entities is assumed to have several different business units. For each business unit of each entity, information is collected regarding past occurrences of each of the types of incidents listed in the right column of TABLE 3. Then, for each business unit of each entity, and for each risk type listed in the middle column of TABLE 3, the information collected about past incidents is allocated among various different cost ranges which reflect the severity of each incident, or in other words the monetary amount of the loss. With respect to the hypothetical scenario being discussed here, FIG. 8 is a bar graph in which each bar represents a different range of severity. The left bar represents losses in the range $0 to $150K, the next bar represents losses in the range of $150K to $250K, the third bar represents losses in the range of $250K to $350K, and so forth. Thus, with respect to the “human resources” risk type, it will be noted from FIG. 8 that business unit A of Xcorp has experienced 40 losses which are each in the range of $0 to $150K, 30 losses which are each in the range $150K to $250K, and so forth.

An entity's appetite or tolerance for risk can be defined as the probability that the entity is willing to accept a loss of a given magnitude, for example a 20% probability that losses will not exceed $10 million. Incident data of the type underlying FIG. 8 can be used to develop a cumulative loss distribution graph, in the form of a curve showing the total losses to a selected dollar level. In the context of the hypothetical scenario being discussed here, FIG. 9 is a graph that shows a cumulative loss distribution curve which corresponds to the information represented in the bar graph of FIG. 8. The curve in FIG. 9 reflects the probability that total annual losses will exceed any given value, based on historical performance. The shape of the curve in FIG. 9 is fairly typical, in that the frequency of incidents decreases with the size or severity of the loss. An effective risk management program seeks to reduce the probability value associated with a selected level of severity or loss. For each participating entity, a respective graph of the type shown in FIG. 9 is prepared for each risk category.

Then, a senior management team from each entity selects a probability value for each graph of the type shown in FIG. 9 which has been prepared for that entity. The team could select the same probability value for all graphs, or a respective different probability value for each of the graphs. For purposes of the present hypothetical scenario, assume that Xcorp selects the same probability value for all graphs, and in particular a probability value of 0.2, or in other words 20%. In the case of FIG. 9, this would mean that Xcorp has chosen an acceptable loss of $300,000 for incidents in the human resources risk category that occur in association with its business unit A.

The dollar value selected for acceptable loss needs to be considered in light of the size of the entity, because $300,000 may be significant for a small business, but negligible for a large business. Therefore, in order to compare the ten entities to each other in a meaningful manner, this risk information must be normalized to the respective sizes of the entities. In the disclosed method, the risk information for each entity is normalized to the net asset value of the entity, or in other words is expressed as a percentage of the corporate assets at risk. However, it would alternatively be possible to normalize this data in some other suitable manner. The use of this normalized risk data will be described later. First, however, it is appropriate to discuss the second general type of information which is collected.

In more detail, the second general type of information relates to the cost of risk management. As explained above, incident information relates to the probability and magnitude of losses which are unexpected and unforeseeable. In contrast, the cost of risk management relates to activities that are intentionally carried out by an entity with the specific goal of trying to manage risks. These latter costs are generally predictable and foreseeable, and are an integral part of each entity's annual budget. These costs of managing risk can be subdivided into two subcategories, which are direct costs and indirect costs.

Direct costs are the costs which are intentionally incurred by an entity for the specific purpose of risk management, in the form of expenses and/or personnel costs. In the chart of accounts used by an entity for its bookkeeping purposes, these direct costs usually appear under line items that are dedicated to risk management activity. In contrast, indirect costs are costs that do not fall within line items dedicated to risk management activity, but instead fall within other line items that are likely to also include costs which do not relate to risk management activity. As one example, legal costs relating to risk management are likely to appear in a legal expenses account which may also include legal costs incurred for other purposes. As another example, contractor expenses relating to risk management (such as consultants on information technology or management) are likely to appear under a line item which is not associated specifically with risk management, and which may also include contractor costs incurred for purposes other than risk management.

TABLE 4
EXAMPLES OF DIRECT COSTS

Insurance Premiums
Fire
Life
Casualty
Property
Business Interruption
Theft
Personnel Salaries and Benefits
Risk Manager
Environmental Manager
Health and Safety Director
Plant Nurse
Facility Costs
Sprinkler Systems
Security Systems
Health Clinic
Consequences
Loss of Sales/Revenue
Loss of Market Share

TABLE 4 is a list of some examples of common risk management costs that are usually handled as direct costs in an entity's chart of account.

TABLE 5
EXAMPLES OF INDIRECT COSTS

Agents/Brokers
Business Interruption
Computer Systems Security
Crisis Management
Disaster Preparedness
Employment Practices
Environmental
Ergonomics
Fraud
Health/Medical
Information & Records
Premiums/Claims/Fines Administration
Intellectual Property
Litigation
Maintenance
Operations Security
Total Quality Management
Political Risk
Process Improvement
Product Recall
Proprietary Information
Safety
Security
Theft
Threat Analysis
Training
Workers Compensation
Workplace Violence

TABLE 5 is a list of some examples of common risk management costs that are usually handled as indirect costs in an entity's chart of accounts. The items listed in each of TABLEs 4 and 5 are merely exemplary, and it will be recognized that each table could include a larger or smaller number of items, and that some or all of the items appearing in each list could be different. For purposes of the method of FIG. 1, the significant consideration is that, in order be able to compare several entities in a meaningful way, each of those entities must collect direct and indirect cost information according to a common standard. Consequently, in the hypothetical scenario under discussion here, each of the ten entities is given the same list of direct and indirect costs as to which it is to collect information. Since a particular type of cost may be treated as a direct cost in the chart of accounts for one entity and as an indirect cost in the chart of accounts for a different entity, the list given to the ten entities need not distinguish between direct and indirect costs.

In regard to the hypothetical scenario, the second column of TABLE 6 contains a list of the direct and indirect costs which is given to each of the ten entities, and each of the ten entities is instructed to collect information about such costs that have been incurred for risk management. In a real world situation, the list of costs would typically be somewhat longer that shown in TABLE 6, but the list in TABLE 6 is a simplified list that is suitable for purposes of explaining the hypothetical scenario. The ten entities each use this same list to collect direct and indirect cost information separately for each business unit and for each of the six risk types (human resources, loan processing, security trading, hardware systems, software systems, and facility security). The four columns on the right side of TABLE 6 show how each cost in the second column may either be applied in its entirety to a single category (where a single column includes an “X”), or may need to be allocated between two or more categories (where two or more columns include an “X”), using standard accounting principles.

TABLE 6
COSTS OF RISK MANAGEMENT

| | | | | | EX- |
|---|---|---|---|---|---|
| | | PEO- | PRO- | SYS- | TERNAL |
| CATEGORY | COSTS | PLE | CESSES | TEMS | EVENTS |
| Insurance | Fire | | | | X |
| | Health/ | X | | | |
| | Medical | | | | |
| | Safety | X | | | |
| | Casualty | | | | X |
| | Property | | | | X |
| | Business | | X | | |
| | Interruption | | | | |
| Corporate | Risk | X | X | X | X |
| Staff | Management | | | | |
| | Legal | X | X | X | X |
| | Information | | | X | |
| | Technology | | | | |
| | Facility | | | | X |
| | Management | | | | |
| Equipment | Fire Alarms/ | | | X | X |
| | Sprinklers | | | | |
| | Warning | | | X | X |
| | Systems | | | | |
| | Security | | | X | X |
| | Locks | | | | |
| | Surveillance | | | X | X |
| | Systems | | | | |
| | Lighting | | | X | X |
| | Security | | | X | X |
| | Software | | | | |
| Consultants | Agents | X | | | X |
| | Brokers | | | | X |
| | Engineering | | X | | X |
| | Financial | | X | | |
| | Computer | | | X | |
| | Systems | | | | |
| | Legal | X | | | X |
| | Management | X | X | | |
| | Telecommuni- | | X | X | |
| | cations | | | | |
| | Safety | | X | | X |
| | Security | | | X | X |

A given entity would typically take the list of all costs from TABLE 6 and split it into two lists, where the first list contains the direct costs which that particular entity can directly extract from its chart of accounts as respective line items, and where the second list contains the indirect costs which are mingled with other costs and which can only be identified through additional manual work, such as searching the chart of accounts and interviewing corporate staff in order to identify each cost and the reason it was incurred.

For each of the six risk types and for each business unit, the cost values are added up to obtain a total, and then the total is normalized. In the disclosed embodiment, each total is normalized to the annual revenues of the particular entity to which the cost information pertains, so that the normalized total represents a percentage of annual revenue that is being expended a given category of risk management. However, it would alternatively be possible to use some other normalization technique, provided that the same normalization technique is used for each participating entity.

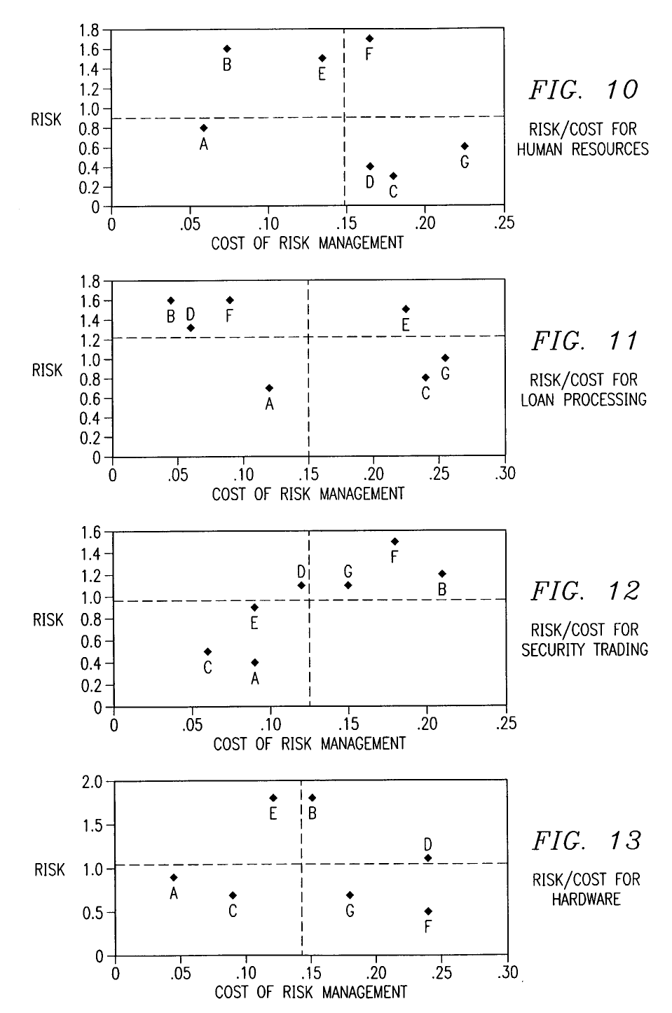

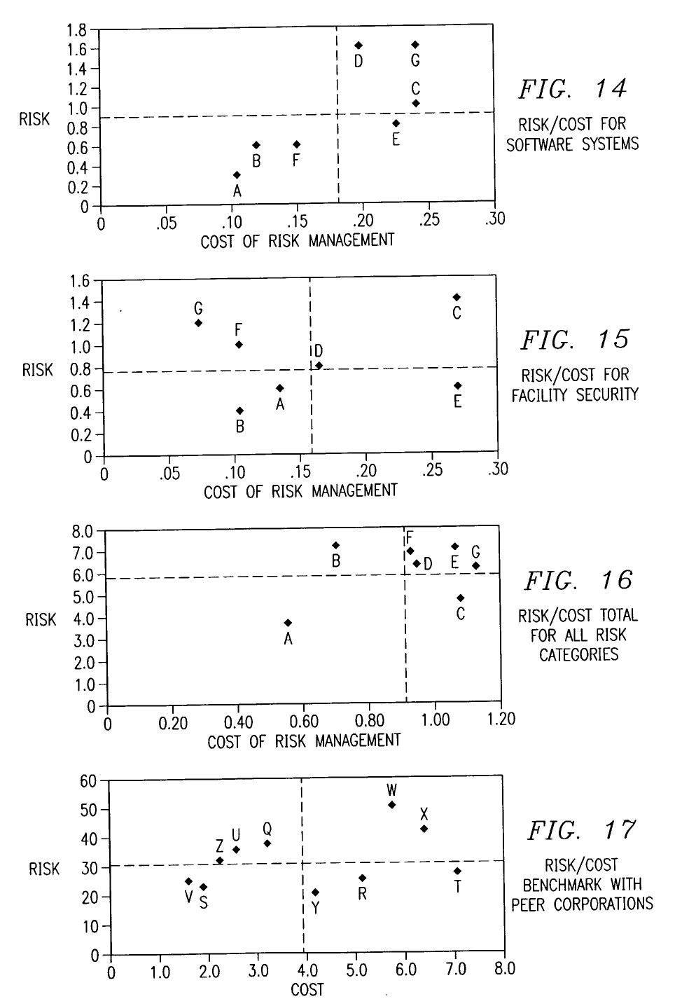

With reference to FIG. 1, activity next moves to block 14, where each participating entity is provided with a respective report, which includes a comparison of the business units of that particular entity, and which includes a comparison of that entity to the other nine participating entities. In this regard, FIGS. 10-15 are respective graphs that each correspond to a respective one of the six risk types discussed above (human resources, loan processing, security trading, hardware systems, software systems, and facility security). Each graph has a horizontal axis which represents the normalized cost of risk management, and has a vertical axis which represents the normalized risk based on past incidents. In each graph, each of the seven business units A-G of Xcorp is represented by a respective single point that has coordinates corresponding to the two normalized values applicable to that particular business unit.

The report provided to each entity also includes a further graph, which is shown in FIG. 16, and which compares the business units of that entity across all six risk types. In particular, for each business unit of the entity, the normalized cost values for each of the six risk types are summed, the normalized risk values for each of the six risk types are summed, and then a point is plotted on a further graph, which is shown in FIG. 16. Each of the seven points in FIG. 16 represents the composite performance across all six risk types of a respective business unit of the entity.

In FIGS. 10-16, the broken lines in each graph indicate the average value along each axis for the seven points which are plotted. Points which are to the left of the vertical broken line and below the horizontal broken line represent business units that are efficiently handling both incident-related risks and also costs of risk management. In contrast, points which are to the right of the vertical broken line and above the horizontal broken line represent business units that are not effectively managing incident-related risks or costs of risk management. FIGS. 10-16 represent the graphs prepared for Xcorp, and only Xcorp would see these graphs. A respective set of seven similar graphs would be prepared for each of the other nine participating entities, and each such entity would thus see only graphs relating to its own business units.

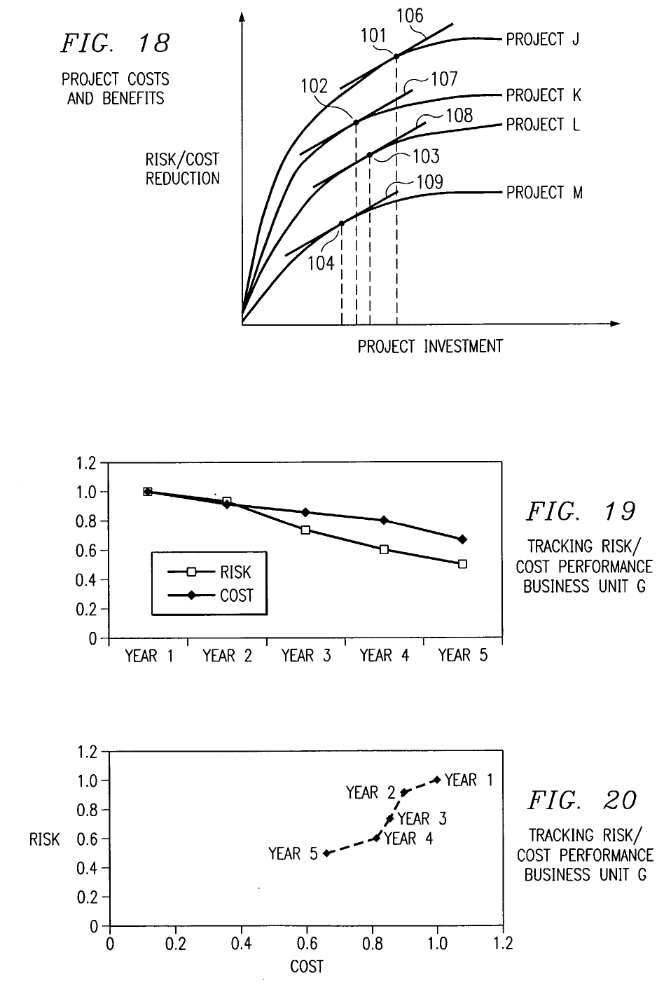

In addition, with reference to block 15 in FIG. 1, the normalized cost values for each of the seven points graphed in FIG. 16 would be summed, and the normalized risk values for each of these seven points would also be summed, and then these two sum values would be used as coordinates to plot in a further graph a point which represents the overall risk management performance of the entire entity. This further graph is shown in FIG. 17, where the point for Xcorp is labeled “X”. For each of the other nine participating entities, a comparable point representing overall risk management performance has been determined and plotted in a similar manner, as also reflected by FIG. 17.

The report provided to each entity would include the graph of FIG. 17, but only the point associated with that particular entity would be labeled in the report provided to that entity. The points representing the other nine entities would be present in the graph, but would not be labeled, so that each entity receiving the report be able to identify its own point, but would not know which other entities were participating in the process, and would not know which of the other points corresponded to which entities. All ten points are labeled in FIG. 17, but this is merely for purposes for facilitating a clear understanding of the present invention. Only one of these points would be labeled in any actual report. Based on the version of the report provided to Xcorp, Xcorp would be able to easily recognize that, in comparison to other participating entities, the overall performance of Xcorp is relatively low in regard to both incident-related risks and also in regard to handling of costs relating to risk management. As a result of this type of information, each report provides real world value and immediate benefit to the entity that receives it.

Next, with reference to block 16 in FIG. 1, each participating entity selects at least one of its own business units, which is lagging its other business units in terms of risk management performance. For example, the graph of FIG. 16 pertains to the business units of Xcorp, and it is possible to see that business unit D, E, F and C are each above average with respect to both axes, representing poor performance in relation to both axes. However, although business units D and F are both above average, neither is significantly above average with respect to either axis. In contrast, business unit G is significantly above average with respect to one axis, and business unit E is significantly above average with respect to both axes. Accordingly, and for purposes of the present hypothetical scenario, it is assumed that Xcorp makes a decision to focus on improving the risk management performance of each of its two business units E and G.

Still referring to block 16, each participating entity then identifies various possible projects (courses of action) which it believes may improve the risk management performance of each business unit that it has selected for attention. The particular projects selected will depend on the particular factual circumstances.

For example, by referring to FIGS. 10-15, Xcorp can easily determine the specific risk types which are contributing most significantly to the problems in each of the business units E and G, and can also determine whether incident-related risk and/or cost of risk management is a significant part of the problem as to each such risk type. Xcorp can then select projects which are specifically tailored to the particular circumstances relating to each of the business units E and G. As one specific example, Xcorp may focus on incident-related data and risk management costs that are associated with loan processing, and determine that errors are occurring because there are too many manual and repetitive steps, and that false information is appearing on applications. The persons performing the analysis for Xcorp can then propose one or more projects which are designed to address these specific problems. For example, the projects might include development of new forms, development of new training classes, improvements to existing training classes, or other appropriate projects. After an initial list of projects has been created, the persons developing the list may evaluate the proposed projects on the list in relation to each other, and then discard a subset of the projects which are believed to be less likely to be effective than other projects on the list, in order to arrive at a final list of projects that will all be implemented.

Activity then proceeds to block 17 in FIG. 1, where each entity identifies a total budget which it is willing to spend to effect implementation of the projects on the list. Then, for each project on the list, the entity evaluates the extent to which progressively greater expenditures on that particular project will produce progressively greater benefit. Typically, the doctrine commonly known as the law of diminishing returns will factor in, such that progressively greater expenditures will produce progressively decreasing benefit for each project.

In this regard, FIG. 18 is a graph showing four curves which each correspond to a one of four hypothetical projects selected by Xcorp, respectively designated here as projects J, K, L and M. The horizontal axis shows the investment in the project, and the vertical axis shows the expected benefit from the project, or in other words the extent to which the project is expected to reduce incident-related risks and/or costs for risk management. On each of the four curves, a point is selected at which the curve has a given slope. For example, it will be noted in FIG. 18 that the respective points 101-104 each represent a point on the associated curve which has a given slope, as reflected by the fact that respective lines 106-109 which diagrammatically represent the slope at each such point are all parallel to each other.

Since the four curves all have the same slope at these four points, the ratio of the rate of change along the horizontal axis to the rate of change along the vertical axis is the same at each of these four points. Thus, at each of the points 101-104, investing an additional dollar in any one of the four projects would result in the same amount of marginal benefit, in terms of risk performance.

The respective monetary values along the horizontal axis for each of these four points 101-104 are then added up, in order to obtain a total cost for all four of these projects. Ideally, this total cost should be the same as the total budget which has been allocated for implementation of all projects. If necessary, the positions of the points 101-104 on the curves can be adjusted (subject to the requirement that the curves each have the same degree of slope at all four selected points), until the total cost equals the total budget. In this manner, a portion of the total budget is allocated to each project, in a manner that maximizes the benefit obtained for the budget.

Thereafter, with reference to block 18 in FIG. 1, each project is implemented to an extent corresponding to the portion of the total budget which has been allocated to that particular project. The implementation of these projects provides a useful, concrete and tangible result with real world benefit in regard to the manner in which the ten entities are handling risk management.

In block 19 of FIG. 1, a determination is made regarding whether this is the first time that the procedure discussed in association with blocks 13-18 has been carried out for the group of participating entities. If so, then block 20 is skipped and, after a suitable business interval such as a quarter or a year, the evaluation process represented by blocks 13-18 is repeated. On the other hand, if it is determined at block 19 that the analysis of blocks 13-18 has previously been carried out at least once for this particular group of participants, the method proceeds to block 20.

In block 20, a report is prepared for each entity, showing not only current but also past risk information for that entity, including past risk information representative of each time that the analysis of blocks 13-18 has been carried out. Each such report provides real world value and immediate benefit to the entity which receives it. For example, in the case of the hypothetical scenario under discussion, assume that the analysis of blocks 13-15 has previously been carried out four times on an annual basis, and has just been completed for the fifth time. FIGS. 19 and 20 are examples of graphs that would be provided to Xcorp, showing how the risk management performance of business unit G has changed from year to year. It will be noted that, due to the projects selected and implemented each year pursuant to blocks 17 and 18 in FIG. 1, business unit G is exhibiting steadily improving risk management performance.

The present invention provides a number of advantages. One advantage is that it offers a comprehensive and systematic approach for measuring, analyzing, benchmarking and mitigating risk and associated cost. A related advantage is that data regarding incident-related risk and costs of risk management are presented in a straightforward but effective manner to executives who can then make decisions and effect changes which will improve the risk management performance of an entity. Still another advantage is that several entities simultaneously participate anonymously with respect to each other, thereby permitting each entity to see how it compares to several other entities in relation to risk management performance. Yet another related advantage is due to the provision of standardized techniques for collecting risk-related data, so as to ensure meaningful comparisons between different entities, or different business units of a given entity.

Although one selected approach has been illustrated and described in detail, it will be understood that various substitutions and alterations are possible without departing from the spirit and scope of the present invention, as defined by the following claims.

What is claimed is:

1. A method, comprising the steps of:
collecting risk management information from each of a plurality of separate entities according to a common standard;
preparing a report which provides a comparison of said entities as a function of said risk management information collected from each of said entities; and
providing said report to one of said entities.

2. A method according to claim 1, wherein said collecting step is carried out so that said risk management information collected for each said entity includes risk information regarding risks experienced by that entity and cost information regarding costs incurred by that entity to manage risks.

3. A method according to claim 2,
including the step of providing a predetermined list enumerating different types of incidents; and
wherein said collecting step includes the step of collecting as said risk information for each said entity only information regarding risks experienced by that entity due to incidents which fall within said predetermined list.

4. A method according to claim 2,
including the step of providing a predetermined list enumerating different types of risk-related costs; and
wherein said collecting step includes the step of collecting as said cost information for each said entity only information regarding costs experienced by that entity which fall within said predetermined list.

5. A method according to claim 2,
including the step of providing a predetermined first list enumerating different types of incidents;
including the step of providing a predetermined second list enumerating different types of risk-related costs; and
wherein said collecting step includes the steps of collecting as said risk information for each said entity only information regarding risks experienced by that entity due to incidents which fall within said first list, and collecting as said cost information for each said entity only information regarding costs experienced by that entity which fall within said second list.

6. A method according to claim 2, wherein said preparing step includes the step of presenting in said report a graph which relates risk to cost of risk management, and which has plotted thereon a plurality of points which are each representative of a respective said entity.

7. A method according to claim 6, including the step of including in said graph an indication of an average value of risk for said entities, and an indication of an average value of cost of risk management for said entities.

8. A method according to claim 6, including the step of configuring said graph to indicate which of said plotted points corresponds to said one of said entities, and to be free of an indication of which of the other said points corresponds to which of the other said entities.

9. A method according to claim 1, wherein said collecting step includes the step of having at least one person associated with each said entity complete a survey which relates to risk management information.

10. A method according to claim 9,
including the step of configuring said survey to include a plurality of statements which relate to risk management activity and which are each to be assigned a numerical score on a predefined scale; and
wherein said step of preparing said report includes the step of calculating for each said entity a score which is a function of the numerical values assigned to said statements by each person associated with that entity who completes said survey.

11. A method according to claim 10,
including the step of assigning a respective weight to each of said statements on said survey; and
wherein said calculating step includes the step of weighting each said numerical value assigned to each said statement as a function of the weight associated with that statement.

12. A method according to claim 10,
wherein said step of configuring said survey includes the step of organizing said statements into a plurality of different categories; and
wherein said calculating step includes the step of calculating for each said category a respective said score which is a function of the numerical values assigned to the statements in that category by each person associated with that entity who completes said survey, said report providing for each said category a respective said comparison of said entities as a function of said risk management information collected from each of said entities for that category.

13. A method according to claim 1, including the step of carrying out said steps of collecting, preparing and providing on a periodic basis.

14. A method according to claim 13, wherein each repetition of said preparing step includes the step of presenting in the report both current and past risk management information collected in association with said collecting step.

15. A method according to claim 1, wherein after said providing step said one of said entities carries out the steps of:
identifying at least one course of action intended to improve the position of said one of said entities with respect to other said entities in regard to risk management; and
implementing said course of action.

16. A method, comprising the steps of:
collecting risk management information from each of a plurality of separate sections of an entity according to a common standard, said risk management information collected from each said section including information regarding risks experienced by that section and information regarding costs incurred by that section to manage risks;
preparing a report which provides a comparison of said sections as a function of said risk management information collected from each of said sections; and
providing said report to one of said entity and a respective said section thereof.

17. A method according to claim 16,
including the step of providing a predetermined list enumerating different types of incidents; and
wherein said collecting step includes the step of collecting as said risk information for each said section only information regarding risks experienced by that section due to incidents which fall within said predetermined list.

18. A method according to claim 17,
wherein said step of providing said list includes the step of grouping said incidents in said list into a plurality of categories;
wherein said collecting step includes the step of collecting said risk information separately for each of said categories in said list; and
wherein said step of preparing said report includes the step of configuring said comparison to provide for each of said categories in said list a respective comparison of said sections as a function of said risk information collected for that category.

19. A method according to claim 16,
including the step of providing a predetermined list enumerating different types of risk-related costs; and
wherein said collecting step includes the step of collecting as said cost information for each said section only information regarding costs experienced by that section which fall within said predetermined list.

20. A method according to claim 19,
wherein said step of providing said list includes the step of grouping said costs in said list into a plurality of categories;
wherein said collecting step includes the step of collecting said cost information separately for each of said categories in said list; and
wherein said step of preparing said report includes the step of configuring said comparison to provide for each of said categories in said list a respective comparison of said sections as a function of said cost information collected for that category.

21. A method according to claim 16,
including the step of providing a predetermined first list enumerating different types of incidents;
including the step of providing a predetermined second list enumerating different types of risk-related costs; and
wherein said collecting step includes the steps of collecting as said risk information for each said section only information regarding risks experienced by that section due to incidents which fall within said first list, and collecting as said cost information for each said section only information regarding costs experienced by that section which fall within said second list.

22. A method according to claim 21,
wherein said step of providing said first list includes the step of grouping said incidents in said first list into a plurality of categories;
wherein said step of providing said second list includes the step of grouping said costs in said second list into said categories;
wherein said collecting step includes the steps of collecting said risk information separately for each of said categories, and collecting said cost information separately for each of said categories; and
wherein said step of preparing said report includes the step of configuring said comparison to provide for each of said categories in said list a respective comparison of said sections as a function of both said risk information and said cost information collected for that category.

23. A method according to claim 16, wherein said preparing step includes the step of presenting in said report a graph which relates risk to cost of risk management and which has plotted thereon a plurality of points that are each representative of a respective said section.

24. A method according to claim 23, including the step of including in said graph an indication of an average value of risk for said sections, and an indication of an average value of cost of risk management for said sections.

25. A method according to claim 16, including the step of carrying out said steps of collecting, preparing and providing on a periodic basis.

26. A method according to claim 25, wherein each repetition of said preparing step includes the step of presenting in the report both current and past risk management information collected in association with said collecting step.

27. A method according to claim 16, wherein after said providing step said entity carries out the steps of:
selecting at least one of said sections thereof which is lagging other said sections thereof with respect to risk management;
identifying for each said selected section at least one course of action intended to improve the position of that section with respect to other said sections in regard to risk management; and
implementing each said course of action.
